(19) United States
(12) Patent Application Publication
(10) Pub. No.: US 2022/0115466 A1
(43) Pub. Date: Apr. 14, 2022

(54) PRIVACY CELLS FOR ELECTRONIC DISPLAYS

(71) Applicant: Hewlett-Packard Development Company, L.P., Spring, TX (US)

(72) Inventors: Hsing-Hung Hsieh, Taipei City (TW); Super Liao, Taipei City (TW); Ann Alejandro Villegas, Spring, TX (US)

(73) Assignee: Hewlett-Packard Development Company, L.P., Spring, TX (US)

(21) Appl. No.: 17/419,311

(22) PCT Filed: Jun. 27, 2019
(86) PCT No.: PCT/US2019/039532

§ 371 Date: Jun. 29, 2021

(51) Int. Cl. H01L 27/32; G02F 1/13; G02F 1/1343

(52) U.S. Cl. CPC H01L 27/3232; G02F 1/13439; G02F 1/1323

(57) ABSTRACT

Example privacy cells and electronic displays including the privacy cells are disclosed. In an example, the electronic display includes an organic light emitting diode (OLED), an anode on a first side of the OLED, and a cathode on a second side of the OLED. In addition, the electronic display includes a privacy cell coupled to the cathode opposite the OLED. The privacy cell includes a cholesteric liquid crystal (CLC) layer on the cathode, and an electrode on the CLC layer opposite the cathode. The electrode and the cathode are to induce a voltage differential across the CLC layer to adjust a viewing angle of the electronic display.

### BACKGROUND

Electronic displays are used in a variety of different ways and in a variety of different types of devices. For example, such displays are a component of devices such as televisions and computer monitors, and are integrally formed within other electronic devices such as, for example, laptop computers, tablet computers, all-in-one computers, smartphones, etc. The images and/or information projected by a display may include, for example, data, documents, textural information, communications, motion pictures, still images, etc. (all of these examples may be collectively referred to herein as “images”).

### BRIEF DESCRIPTION OF THE DRAWINGS

Various examples will be described below referring to the following figures:

FIG. 1 is a front view of an electronic device including a display according to some examples;

FIG. 2 is a side view of the electronic device of FIG. 1 according to some examples;

FIG. 3 is a schematic cross-sectional view of the display of the electronic device of FIG. 1 according to some examples;

FIG. 4 is an enlarged schematic cross-sectional view of the display of the electronic device of FIG. 1 according to some examples;

FIG. 5 is a schematic cross-sectional view of the display of the electronic device of FIG. 1 operating in a public viewing mode according to some examples;

FIG. 6 is a schematic cross-sectional view of the display of the electronic device of FIG. 1 operating in a private viewing mode according to some examples;

FIG. 7 is a block diagram of a method of adjusting a viewing angle of an electronic display according to some examples; and

FIG. 8 is a block diagram of another method of adjusting a viewing angle of an electronic display according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

As used herein, the term “electronic device,” refers to a device that is to carry out machine readable instructions, and may include internal components, such as, processors, power sources, memory devices, etc. For example, an electronic device may include, among other things, a personal computer, a smart phone, a tablet computer, a laptop computer, a personal data assistant, etc. As used herein, the term “display” refers to an electronic display (e.g., an organic light emitting diode (OLED) display, a liquid crystal display (LCD), a plasma display, etc.) that is to display images generated by an associated electronic device. The term “flexible display” refers to an electronic display that may be deformed (e.g., rolled, folded, etc.) within a given parameter or specification (e.g., a minimum radius of curvature) without losing electrical function or connectivity.

As previously described above, electronic displays (or more simply “displays”) are utilized to project images and/or information (which are collectively referred to herein as “images”) for viewing by a user or plurality of users. In some instances, displays are used to project images that are considered confidential or sensitive. Thus, the intended or authorized viewer of the display may wish to limit the visibility of the images on the display to a select viewing position or positions relative to the display. Accordingly, examples disclosed herein include electronic displays that are to selectively restrict the visibility of the images projected thereby to a preselected viewing position or number of viewing positions.

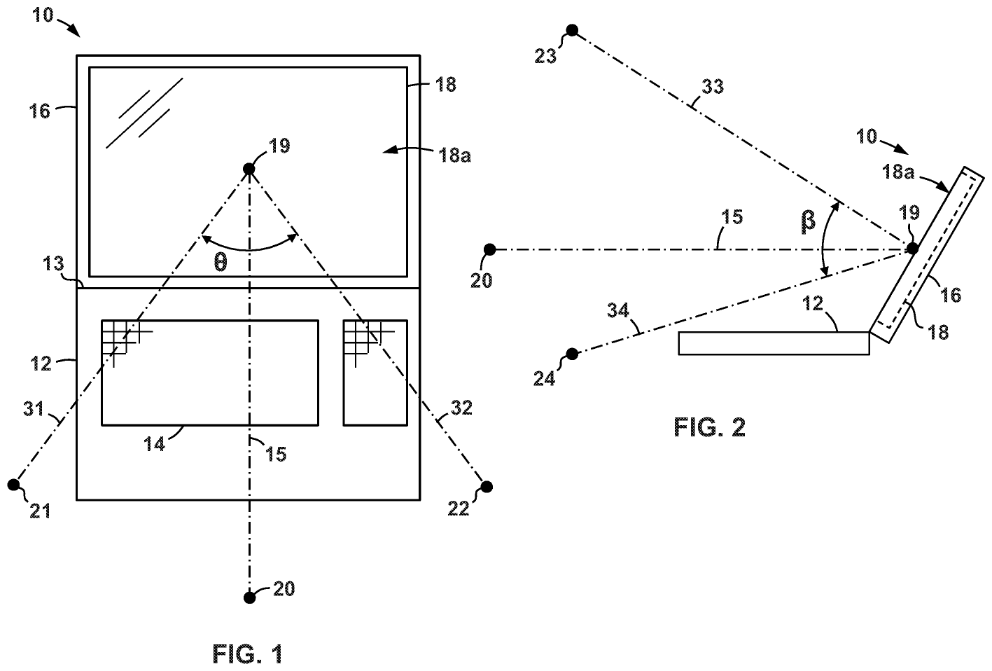

Referring now to FIG. 1, an electronic device 10 according to some examples is shown. In this example, electronic device 10 is a laptop computer that includes a first housing member 12 rotatably coupled to a second housing member 16 at a hinge 13. The first housing member 12 includes a user input device, such as, for example, a keyboard 14. The second housing member 16 includes an electronic display 18 (or more simply “display 18”) that is to project images out of a front side or surface 18a for viewing by a user (not shown) of the electronic device 10. In some examples, display 18 may be a flexible display; however, display 18 may not be a flexible display in other examples.

Referring now to FIGS. 1 and 2, a user may be positioned in front of the display 18 of electronic device 10 at a position 20. Position 20 may be disposed at or near a “zero-axis” position relative to display 18 so that position 20 is directly in front of display 18 (or nearly directly in front). In particular, position 20 may be disposed along an axis 15 that extends outward from a center 19 of display 18. Axis 15 may extend perpendicularly from the lateral span of display 18. Thus, position 20 may be referred to herein as front viewing position.

Display 18 may be viewable from other positions other than the front viewing position 20, such as viewing positions that are laterally and/or vertically shifted from the front viewing position 20. Therefore, display 18 defines a first viewing angle θ, and a second viewing angle β that extends perpendicular to the first viewing angle θ. Because first housing member 12 of electronic device 10 may be placed flat on a laterally oriented support surface (e.g., table, desk, etc.), the first viewing angle θ may be referred to herein as a “lateral viewing angle θ” and the second viewing angle β may be referred to herein as a “vertical viewing angle β,” in the context of electronic device 10.

As best shown in FIG. 1, the lateral viewing angle θ may extend between a pair of off-axis viewing positions 21, 22 that are laterally shifted from the front viewing position 20. Off-axis viewing positions 21, 22 represent the most extreme positions to the left and right, respectively, from the display 18 from which a viewer may still see or discern the images projected therefrom. Viewing positions that are shifted laterally outside or beyond the positions 21, 22 may represent positions from which a viewer may no longer see or discern the images projected by display 18. Each viewing position 21, 22 may have a line of sight or axis 31, 32, respectively, extending between the positions 21, 22, respectively, and the center 19 of display 18. Together, the axes 15, 31, 32 define a first plane, and the first viewing angle θ extends within this plane between the axes 31, 32. Because first housing member 12 is typically disposed on a lateral support surface during operations as previously described, the first plane defined by axes 15, 31, 32 may be a lateral plane.

As best shown in FIG. 2, the vertical viewing angle β may extend between a pair of off-axis viewing positions 23, 24 that are vertically shifted from the front viewing position 20. Off-axis viewing positions 23, 24 represent the most extreme positions above and below, respectively, from the display 18 from which a viewer may still see or discern the image projected therefrom. Viewing positions that are shifted vertically outside or beyond the positions 23, 24 may represent positions from which a viewer may no longer see or discern the images projected by display 18. Each viewing position 23, 24 may have a line of sight or axis 33, 34, respectively, extending between the positions 23, 24, respectively, and the center 19 of display 18. Together, the axes 15, 33, 34 define a second plane, and the second viewing angle β extends within this plane between the axes 33, 34. As can be appreciated from FIGS. 1 and 2, the second plane defined by axes 15, 33, 34 is perpendicular to the first plane defined by axes 15, 31, 32. In addition, because first housing member 12 is typically disposed on a lateral support surface during operations as previously described, the second plane defined by axes 15, 33, 34 may be a vertically oriented plane.

As will be described in more detail below, display 18 includes a privacy cell that is to selectively adjust or limit the viewing angles θ, β of display 18 so as to provide selective privacy from off-axis viewers that are vertically and/or laterally adjacent to the front viewing position 20. This function and specific example structures of display 18 will now be described in more detail below.

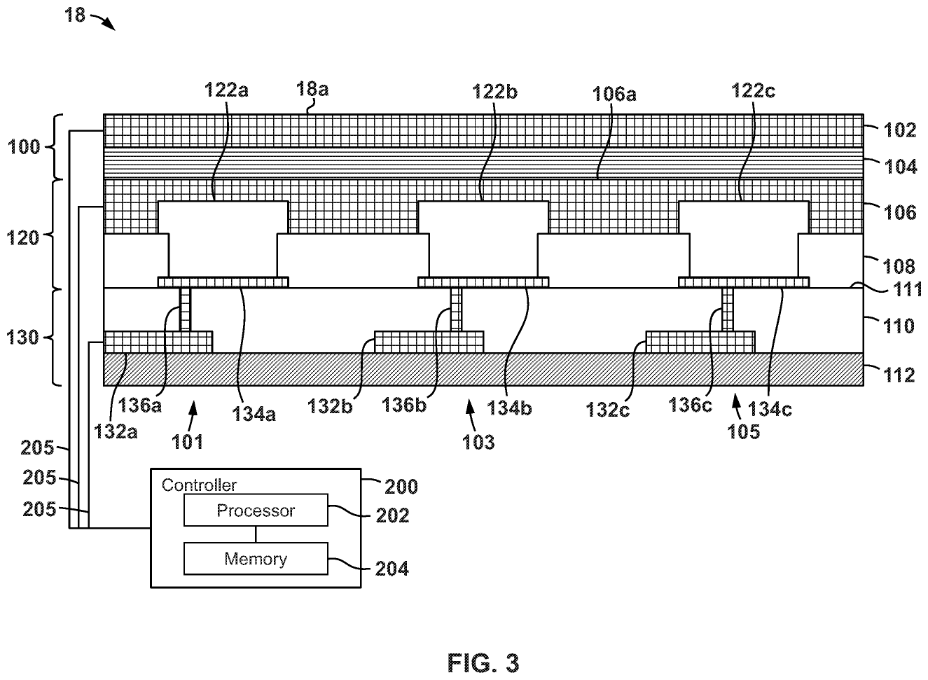

Referring now to FIG. 3, an example of display 18 for use within electronic device 10 of FIGS. 1 and 2 is shown. Generally speaking, display 18 includes a thin film transistor (TFT) 130, an organic light emitting diode (OLED) assembly 120, and a privacy cell or panel 100. The OLED assembly 120 may be disposed atop the TFT 130, and the privacy cell 100 may be disposed atop the OLED assembly 120. In addition, it should be appreciated that display 18 may include a plurality of pixels arranged in a plurality of columns and rows, and each pixel may include a plurality of sub-pixels associated with a plurality of colors. FIG. 3 shows one pixel of display 18, which comprises a total of three sub-pixels 101, 103, 105. As will be described in more detail below, sub-pixels 101, 103, 105 may emit a specific color, such as, red, green, and blue, respectively, in this example. During operations, different ones or combinations of the sub-pixels may emit the colored light so as to provide a desired color from the pixel which thereby forms an image that is emitted or projected from front surface 18a of display 18 as previously described. In this example, privacy cell 100 forms the front surface 18a of display 18. However, in other examples, additional layer(s) and/or component(s) may be disposed on top of the privacy cell 100, such that these additional layer(s) and component(s) may form the front surface 18a.

Generally speaking, TFT 130 includes a substrate 112 and a plurality of sub-pixel electrodes 132a, 132b, 132c mounted to the substrate 112. Each sub-pixel electrode 132a, 132b, 132c is associated with a corresponding pixel of display 18. Because FIG. 3 depicts a single pixel of display 18 as previously described, the three sub-pixel electrodes 132a, 132b, 132c associated with this depicted pixel are shown. Each sub-pixel electrode 132a, 132b, 132c may be selectively energized with electric current, and thus may comprise any suitable conductive material(s) (e.g., indium-tin-oxide). In some examples, TFT 130 may comprise a low-temperature polycrystalline silicon (LTPS) TFT, an oxide TFT, an organic TFT, or any other suitable TFT structure.

In addition, TFT 130 includes a plurality of leads or connectors 136a, 136b, 136c that are electrically coupled to the sub-pixel electrodes 132a, 132b, 132c, respectively. Thus, during operations, electrical current that is provided to the sub-pixel electrodes 132a, 132b, 132c may be conducted to connectors 136a, 136b, 136c, respectively. Further, a preservation layer 110 may be applied on top of the substrate 112 and about the sub-pixel electrodes 132a, 132b, 132c and connectors 136a, 136b, 136c. In some examples, preservation layer 110 is an electrically insulating material, and thus, during operations, electrodes 132a, 132b, 132c are electrically insulated from one another, and connectors 136a, 136b, 136c are electrically insulated from one another via preservation layer 110. In addition, connectors 136a, 136b, 136c are electrically insulated from non-corresponding sub-pixel electrodes 132a, 132b, 132c via preservation layer 110. Specifically, connector 136a is electrically insulated from sub-pixel electrodes 132b, 132c, connector 136b is electrically insulated from sub-pixel electrodes 132a, 132c, and connector 136c is electrically insulated from sub-pixel electrodes 132b, 132c all via preservation layer 110.

Preservation layer 110 may comprise any suitable electrically insulating material, such as, for instance, a polymer. In various examples, preservation layer 110 may be opaque, translucent, or transparent. In some examples, the preservation layer 110 may be poured or deposited on top of substrate 112, sub-pixel electrodes 132a, 132b, 132c, and connectors 136a, 136b, 136c in a liquid or semi-liquid state prior to drying and/or curing. Once dry and/or cured, the preservation layer 110 may form a relatively flat or planar upper surface 111.

Thin film transistor 130 may include a plurality of other components (e.g., common electrode(s), polarizer(s), substrate(s), etc.). However, these additional features are not shown in FIG. 3 in the interest of brevity.

OLED assembly 120 includes a plurality of sub-pixel anodes 134a, 134b, 134c, a plurality of OLEDs 122a, 122b, 122c, and a common cathode 106. The sub-pixel anodes 134a, 134b, 134c are disposed on planar upper surface 111 of preservation layer 110. In addition, the OLEDs 122a, 122b, 122c are coupled to and disposed atop the sub-pixel anodes 134a, 134b, 134c, and the common cathode 106 is coupled to and disposed atop the OLEDs 122a, 122b, 122c. Sub-pixel anodes 134a, 134b, 134c are electrically coupled to connectors 136a, 136b, 136c, respectively. Thus, sub-pixel anodes 134a, 134b, 134c are electrically coupled to sub-pixel electrodes 132a, 132b, 132c via connectors 136a, 136b, 136c, respectively.

Sub-pixel anodes 134a, 134b, 134c may comprise an opaque electrically conductive material in some examples. For instance, sub-pixel anodes 134a, 134b, 134c may comprise aluminum, silver, or other metal alloys (e.g., such as those described herein). In addition, connectors 136a, 136b, 136c may also comprise an electrically conductive material (e.g., any of the metals or metal alloys mentioned above).

Common cathode 106 may comprise a sheet or layer (or multiple sheets or layers) of conductive materials that are to conduct electrical current therethrough during operations. In some examples, cathode 106 is a semi-transparent so that the images or information projected by the corresponding display (e.g., display 18) are not blocked or substantially obstructed by cathode 106. In some examples, the cathode 106 may comprise an electrically conductive material, such as, for instance, indium-tin-oxide, indium-zinc-oxide, aluminum, silver, magnesium, or a combination thereof. However, other materials are also contemplated herein for cathode 106 in other examples. In addition, cathode 106 extends over all pixels of display 18, and thus is referred to herein as a “common” cathode 106.

During operations, electrical current may be supplied to the common cathode 106 and select ones of the sub-pixel anodes 134a, 134b, 134c (e.g., via the sub-pixel electrodes 132a, 132b, 132c and connectors 136a, 136b, 136c, respectively). The electrical current may then flow across the OLEDs 122a, 122b, 122c which thereby induces the OLEDs 122a, 122b, 122c to emit light. Specifically, as previously described above, each OLED 122a, 122b, 122c may emit a different shade or color of light. In some examples, OLED 122a may emit a red light, OLED 122b may emit a green light, and OLED 122c may emit a blue light. Different combinations of the colored lights emitted from OLEDs 122a, 122b, 122c may be combined to generally emit a combined color of light from the overall pixel (e.g., the pixel collectively formed by sub-pixels 101, 103, 105). The light emitted from the pixels of display 18 (one of which being depicted in FIG. 3) may then be combined to form an image for viewing.

Referring still to FIG. 3, an insulation layer 108 may be disposed about the sub-pixel anodes 134a, 134b, 134c and partially about OLEDs 122a, 122b, 122c. The insulation layer 108 may comprise an electrically insulating material, and may comprise the same material forming preservation layer 110 (previously described). Thus, the same description above for the preservation layer 110 may be applied to describe insulation layer 108 as well. During operations, insulation layer 108 may function to electrically insulate the sub-pixel anodes 134a, 134b, 134c from one another. In addition, as is also described above for the preservation layer 110, insulation layer 108 may be applied to sub-pixel anodes 134a, 134b, 134c and about OLEDs 122a, 122b, 122c in a liquid or semi-liquid state.

Privacy cell 100 includes a cholesteric liquid crystal (CLC) layer 104 disposed on the common cathode 106, and a common electrode 102 disposed on the CLC layer 104. Thus, CLC layer 104 may directly engage with a top surface 106a of common cathode 106. Common electrode 102 may comprise a sheet or layer (or multiple sheets or layers) of conductive materials that are to conduct electrical current therethrough during operations. In some examples, electrode 102 is a semi-transparent so that the images projected by the corresponding display (e.g., display 18) are not blocked or obstructed by electrode 102. In some examples, the electrode 102 may comprise an electrically conductive material, such as, for instance, indium-tin-oxide, indium-zinc-oxide, aluminum, silver, magnesium, or a combination thereof. However, other materials are also contemplated herein for cathode 106 in other examples. In addition, as was previously described above for common cathode 106, electrode 102 may extend over all of the pixels of display 18, and thus is referred to herein as a “common” electrode.

The CLC layer 104 may comprise a plurality of sub-layers of liquid crystals having pre-determined orientations. Specifically, in some examples, the liquid crystals may have different pre-determined orientations through the various sub-layers. In some examples, the liquid crystals of CLC layer 104 may be oriented in a generally helical arrangement when moving through the various sub-layers. When a voltage differential is applied across the CLC layer 104 (e.g., via the common cathode 106 and common electrode 102 as described in more detail below), the liquid crystals disposed therein may re-arrange themselves based on the voltage differential and thereby alter a reflectivity of the CLC layer 104.

Specifically, in some examples, as a voltage differential across the CLC layer 104 increases, the reflectivity of the CLC layer 104 may also increase. Conversely, as a voltage differential across the CLC layer 104 decreases, reflectivity of the CLC layer 104 also decreases. However, this functionality may be altered (e.g., switched) in other examples such that an increasing voltage differential may decrease a reflectivity of the CLC layer 104 and a decreasing voltage differential may increase a reflectivity of the CLC layer 104. In these alternative examples, the initial predetermined orientations of the liquid crystals within the CLC layer 104 may be adjusted to achieve this alternative reflectivity response.

Referring still to FIG. 3, a controller 200 may be coupled to display 18 to selectively supply electric current to the sub-pixel electrodes 132a, 132b, 132c, the common cathode 106, and the common electrode 102 during operations. Controller 200 may be a standalone controller for display 18, and/or may be incorporated within a general purpose controller within an electronic device (e.g., electronic device 10 in FIG. 1). Generally speaking, controller 200 includes a processor 202 and a memory 204. The processor 202 (e.g., microprocessor, central processing unit, or collection of such processor devices, etc.) executes machine readable instructions (e.g., non-transient machine-readable instructions) provided on memory 204 to provide the processor 202 with all of the functionality described herein. The memory 204 may comprise volatile storage (e.g., random access memory), non-volatile storage (e.g., flash storage, read-only memory, etc.), or combinations of both volatile and non-volatile storage. Data consumed or produced by the machine-readable instructions can also be stored on memory 204. Controller 200 may also include or be coupled to a power source (not shown). The power source may comprise any suitable source of electrical power such as, for example, a battery, capacitor, a converter or transformer, wall plug, etc.

Controller 200 may be coupled to the electrodes 102, 132a, 132b, 132c, and cathode 106 via a plurality of conductors 205. Conductors 205 may comprise any suitable conductive conduit, path, and the like for conducting electrical, light, or other signals therealong during operations. For instance, in some examples, conductors 205 (or some of the conductors 205) may comprise conductive wires, fiber optic lines, conductive traces, etc. In addition, in some examples, some portion of the components of controller 200 may communicate wirelessly with electrodes 102, 132a, 132b, 132c, and/or cathode 106.

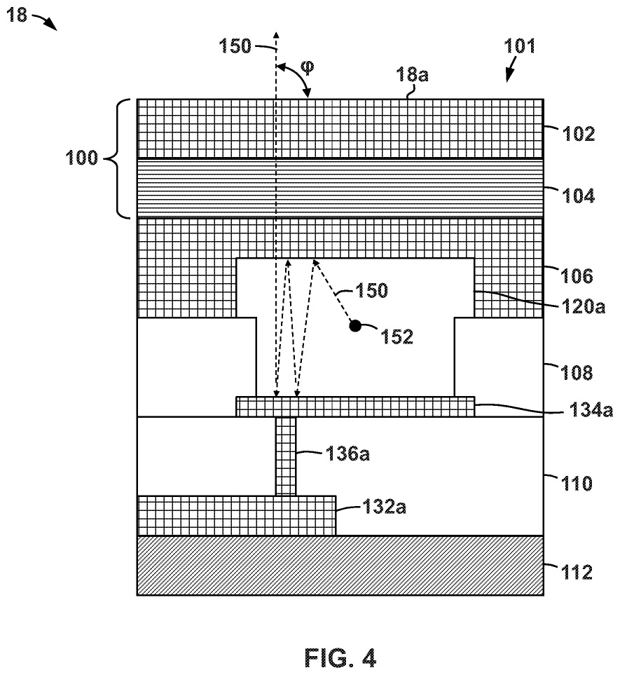

As previously described, light is selectively emitted from the OLEDs 122a, 122b, 122c of each pixel of display 18, so as to form an image during operations. Generally speaking the light generated within the OLEDs of display 18 (e.g., OLEDs 122a, 122b, 122c) is emitted in all directions. For instance, reference is now made to FIG. 4, which shows a single sub-pixel 101 from the pixel depicted in FIG. 3. Specifically, FIG. 4 shows the OLED 122a, and the corresponding sub-pixel anode 134a, connector 136a, and sub-pixel electrode 132a of sub-pixel 101 along with the other components of display 18 previously described above (e.g., electrodes 102, cathode 106, CLC layer 104, insulation layer 108, preservation layer 110, substrate 112, etc.). During operations, electrical current is supplied to the OLED 122a via the sub-pixel anode 134a and the common cathode 106 as previously described. As a result, light is generated within the OLED 122a that is then emitted outward in all directions. However, while various components of display 18 may be transparent or nearly transparent as previously described above, common cathode 106 and sub-pixel anode 134a may have some amount of reflectivity with respect to visible light. Thus, the light generated within the OLED 122a may be reflected across the OLED 122a (e.g., between the cathode 106 and anode 134a) a number of times before eventually being emitted from the display 18.

Specifically, FIG. 4 shows a single light ray 150 emitted from a point or origin 152 within OLED 122a. Upon being emitted from the origin 152, the light ray 150 is reflected back and forth between the cathode 106 and anode 134a until it is eventually emitted through cathode 106, CLC layer 104, and electrode 102 toward a viewer. The reflectivity of the layers surrounding the OLED 122a determines the number of times that the light ray 150 is reflected across the OLED 122a before eventually being emitted from display 18. Specifically, as the reflectivity of anode 134a, cathode 106, and/or CLC layer 104, etc., increases, the number of reflections of light ray 150 also generally increases. In addition, as the number of reflections of light ray 150 increases, the emitted light ray 150 may be increasingly more perpendicular to an outer surface 18a of the display 18. In other words, as number of reflections of light ray 150 increases between cathode 106 and anode 134a, an angle φ between the finally emitted light ray 150 and outer surface 18a of display 18 may converge closer and closer to approximately 90°. When this phenomenon is applied to the multitude of light rays emitted from the plurality of other sub-pixels within a display 18 (e.g., sub-pixels 101, 103, 105, etc.), an increasing reflectivity of the display layers surrounding the OLEDs (e.g., OLEDs 122a, 122b, 122c, etc.) may cause the light emitted from the display 18 to become more collimated and thus more normal (perpendicular) to a front surface 18a of the display 18 (e.g., surface 18a of display 18).

Therefore, in the examples disclosed herein, a reflectivity of a layer disposed atop the OLEDs (e.g., namely the CLC layer 104) may be selectively altered during operations so as to selectively adjust an angle of light rays emitted from display 18. In this manner, a viewing angle of display 18 (e.g., viewing angles θ, β shown in FIGS. 1 and 2) may be selectively limited so as to provide additional privacy for images projected by display 18 during operations. Additional details of the operations with display 18 (including privacy cell 100) are provided below.

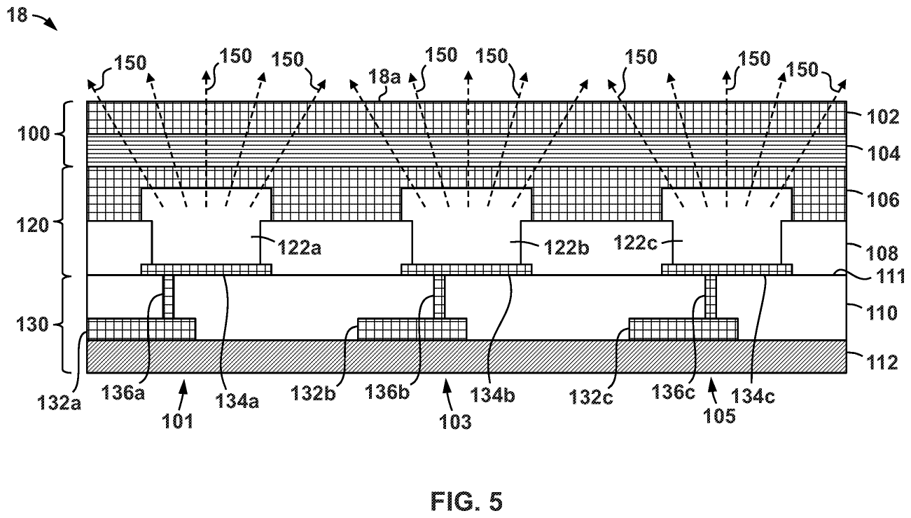

Specifically, referring now to FIGS. 1, 2, 5, and 6, during operations, a user may selectively alter a reflectivity of the CLC layer 104 within privacy cell 100 to thereby increase or decrease viewing angles θ and/or β of the display 18. Initially, as shown in FIG. 5, display 18 may be operated in public (or non-private) viewing mode wherein the reflectivity of CLC layer 104 is relatively low. As a result, the light emitted from OLEDs 122a, 122b, 122c is reflected relatively little between the cathode 106 and anodes 134a, 134b, 134c, and is therefore emitted from display 18 in a relatively wide cone or range. As a result, when operated in the non-private mode, the viewing angles θ, β shown in FIGS. 1 and 2 may be relatively large so that viewers at relatively extreme side and vertical positions may still discern the images projected from display 18.

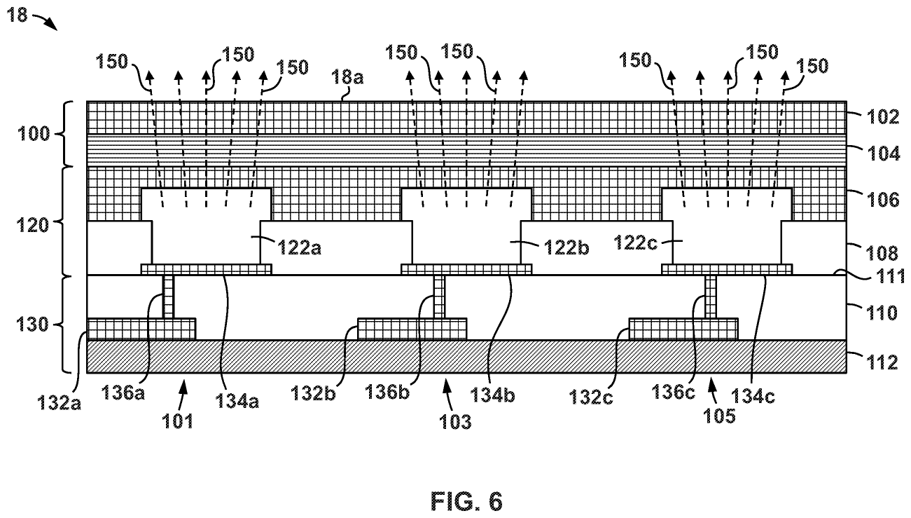

However, as shown in FIG. 6, if a user wishes to limit the viewability of the images projected from display 18, a suitable electrical current may be supplied to electrode 102 so as to increase a reflectivity of CLC layer 104. As previously described above, in some examples, an increasing voltage differential between cathode 106 and electrode 102 may result in an increased reflectivity of the CLC layer 104. Thus, in some examples, suitable electrical current may be supplied to electrode 102 to increase the voltage differential between electrode 102 and cathode 106 and thereby also increase the reflectivity of CLC layer 104. As previously described above, as the reflectivity of CLC layer 104 increases the light rays emitted from display 18 become more collimated or perpendicular relative to the front surface 18a of display 18. As a result, as the reflectivity of the CLC layer 104 increases, viewing angles θ, β of the display 18 decrease such that viewers disposed at relatively extreme side and vertical positions may no longer discern the images projected from display 18. Specifically, because less and less light is emitted at large angles from the display 18 when the reflectivity of CLC 104 is increased, viewers at such extreme angled positions may see a relatively dim image (such that the overall viewability of the image is decreased for such viewers). Therefore, during these operations the change in the viewing angle (e.g., angles θ, β) of display 18 may be relative to the change in the voltage differential across the CLC layer 104 and the resulting change in the reflectivity of the CLC layer 104.

The adjustments in the reflectivity of CLC layer 104 may be driven by adjustments in the electric current supplied to electrode 102 of privacy cell 100 and possibly to cathode 106 of OLED assembly 120. Specifically, controller 200 (see e.g., FIG. 3) may selectively adjust the current supplied to electrode 102 and/or cathode 106 to thereby selectively adjust the reflectivity of CLC layer 104 and thus ultimately adjust the viewing angles θ, β per the selection of the user of electronic device 10. Because the viewing angles θ, β are defined in perpendicular planes as previously described above, when controller 200 adjusts the reflectivity of CLC layer 104, the viewing angle of the display 18 is adjusted in a first plane defined by the axes 15, 31, 32 (e.g., a lateral plane) as shown in FIG. 1, and a second plane defined by axes 15, 33, 34 (e.g., a vertical plane) shown in FIG. 2.

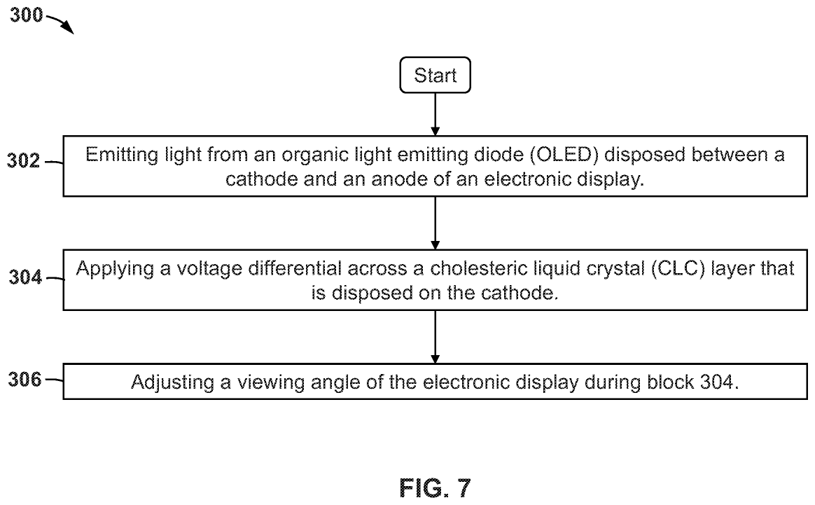

Referring now to FIG. 7, a method 300 of adjusting a viewing angle of an electronic display (e.g., electronic display 18) is shown. In describing the features of method 300, reference will be made to display 18 shown in FIGS. 1-6; however, it should be appreciated that method 300 may also be practiced with other electronic displays that may be different in some respects from display 18.

Initially, method 300 includes emitting light from an organic light emitting diode (OLED) disposed between a cathode and an anode of an electronic display at 302. For instance, as previously described above for display 18 shown in FIGS. 1-6, light may be emitted from the OLEDS 122a, 122b, 122c by energizing anodes 134a, 134b, 134c and/or cathode 106 with electric current as previously described above.

Referring again to FIG. 7, method 300 also includes applying a voltage differential across a cholesteric liquid crystal (CLC) layer that is disposed on the cathode at 304. For example, for display 18 in FIGS. 1-6, a voltage differential may be applied across the CLC layer 104 by energizing the cathode 106 and/or electrode 102 with electric current. As previously described above, applying a voltage differential across the CLC layer 104 may cause the liquid crystals within the CLC layer 104 to adjust their orientations such that a reflectivity of the CLC layer 104 is altered or adjusted.

Referring again to FIG. 7, method 300 next includes adjusting a viewing angle of the electronic display during block 304, at 306. For instance, as described above for the display 18 of FIGS. 1-6, when a reflectivity of the CLC layer 104 is adjusted (e.g., increased or decreased), the light rays emitted from the OLEDs 122a, 122b, 122c may be more or less collimated (and thus more or less perpendicular to a front surface 18a of display 18). The angle of the light rays emitted from the display 18 may affect a viewing angle (e.g., viewing angles θ and/or β shown in FIGS. 1 and 2) of display 18. Thus, a user may place the display 18 in a private viewing mode, having limited values for the viewing angles θ, β by adjusting a voltage differential across CLC layer 104 and thus a reflectivity thereof during operations.

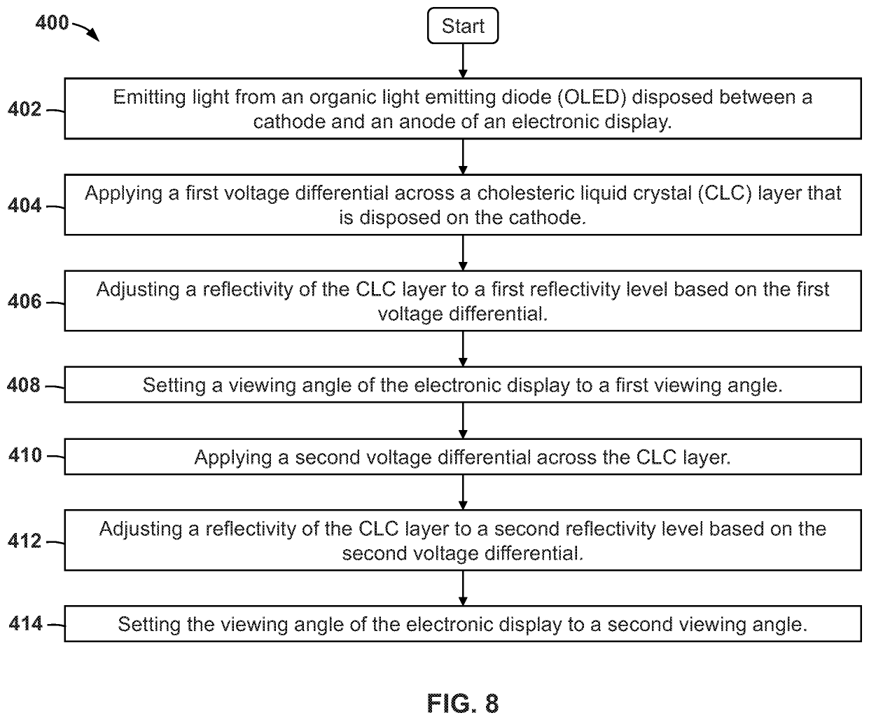

Referring now to FIG. 8, a method 400 for adjusting a viewing angle of an electronic display (e.g., electronic display 18) is shown. In describing the features of method 400, reference will be made to display 18 shown in FIGS. 1-6; however, it should be appreciated that method 400 may also be practiced with other electronic displays that may be different in some respects from display 18.

Initially, method 400 includes emitting light from an organic light emitting diode (OLED) disposed between a cathode and an anode of an electronic display at 402. For instance, as previously described above for display 18 shown in FIGS. 1-6, light may be emitted from the OLEDS 122a, 122b, 122c by energizing anodes 134a, 134b, 134c and/or cathode 106 with electric current as previously described above.

Referring again to FIG. 8, method 400 also includes applying a first voltage differential across a cholesteric liquid crystal (CLC) layer that is disposed on the cathode at 404. For example, for display 18 in FIGS. 1-6, a voltage differential may be applied across the CLC layer 104 by energizing the cathode 106 and/or electrode 102 with electric current.

Referring to FIG. 8, method 400 also includes adjusting a reflectivity of the CLC layer to a first reflectivity level based on the first voltage differential at 406. As previously described above for display 18 shown in FIGS. 1-6, applying a voltage differential across the CLC layer 104 may cause the liquid crystals within the CLC layer 104 to adjust their orientations such that a reflectivity of the CLC layer 104 is altered or adjusted. Thus, a reflectivity of the CLC layer 104 may be based on a voltage differential applied thereacross.

Referring again to FIG. 8, method 400 also includes setting a viewing angle of the electronic display to a first viewing angle at 408. For instance, for the display 18 of FIGS. 1-6, a viewing angle(s) (e.g., viewing angles θ, β shown in FIGS. 1 and 2) may be adjusted by altering a reflectivity of the CLC layer 104.

Referring again to FIG. 8, method 400 also includes applying a second voltage differential across the CLC layer at 410, adjusting a reflectivity of the CLC layer to a second reflectivity level based on the second voltage differential at 412, and setting the viewing angle of the electronic display to a second viewing angle at 414. As previously described above for display 18, as the reflectivity of the CLC layer 104 increases, light is reflected more times across the corresponding OLED (e.g., OLEDs 122a, 122b, 122c, etc.) such that it becomes more normal or perpendicular to front surface 18a (e.g., or more collimated) upon being emitted from display 18 during operations. As the light from display 18 becomes more collimated, the viewing angles θ, β are more limited, and viewers disposed outside of the viewing angles may see a relatively dim image. Thus, for method 400 in FIG. 8 if the second viewing angle at 414 is smaller than the first viewing angle at 408 (e.g., such that the second viewing angle at 414 may be associated with a privacy mode for the electronic display and the first viewing angle at 408 may be associated with a public mode for the electronic display), then the second reflectivity level of 412 is greater than the first reflectivity level at 406.

In addition, as was previously described for display 18 of FIGS. 1-6, in some examples, an increasing voltage differential across CLC layer 104 may cause or correspond with an increasing reflectivity of CLC layer 104 (and thus a decreasing viewing angle of display 18). Thus, in some examples, if the second viewing angle of 414 is smaller than the first viewing angle of 408, the first voltage differential of 404 may be smaller than the second voltage differential of 410. In some examples, the first voltage differential may be zero (or substantially zero). However, in other examples, a decreasing voltage differential may be may cause or correspond with an increasing reflectivity of CLC layer 104, such that if the second viewing angle of 414 is smaller than the first viewing angle of 408, the first voltage differential at 404 may be greater than the second voltage differential at 410 in these examples.

Examples disclosed herein have included electronic displays that are to selectively restrict the visibility of the images projected thereby to a preselected viewing position or number of viewing positions (e.g., viewing angles θ, β of display 18). Thus, a user of the display (and/or an associated electronic device) may more adequately protect sensitive or confidential images projected by the display by selectively limiting the visible viewing angle(s) of a display during operations.

While the above discussed displays (e.g., display 18) have been described for use within laptop electronic device 10 shown in FIGS. 1 and 2, it should be appreciated that the displays and privacy panels described herein may also be included in any other device or assembly that includes or incorporates an electronic display. For example, the above described displays and/or privacy panels may be included in computer monitors, televisions, smartphones, tablet computers, electronic picture frames, etc.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. An electronic display, comprising:
an organic light emitting diode (OLED);
an anode on a first side of the OLED;
a cathode on a second side of the OLED; and
a privacy cell coupled to the cathode opposite the OLED, wherein the privacy cell comprises:
a cholesteric liquid crystal (CLC) layer on the cathode; and
an electrode on the CLC layer opposite the cathode, wherein the electrode and the cathode are to induce a voltage differential across the CLC layer to adjust a viewing angle of the electronic display.

2. The electronic display of claim 1, wherein the electrode and the cathode are to induce a voltage differential across the CLC layer to adjust a reflectivity of the CLC layer.

3. The electronic display of claim 2, comprising a controller coupled to the privacy cell and the cathode, wherein the controller is to apply a first voltage differential across the CLC layer, between the cathode and the electrode to decrease a reflectivity of the CLC layer and to increase a viewing angle of the electronic display.

4. The electronic display of claim 3, wherein the controller is to apply a second voltage differential across the CLC layer, between the cathode and the electrode to increase a reflectivity of the CLC layer and decrease a viewing angle of the electronic display.

5. The electronic display of claim 4, wherein the first voltage differential is smaller than the second voltage differential.

6. A method of changing a viewing angle of an electronic display, the method comprising:
(a) emitting light from an organic light emitting diode disposed between a cathode and an anode of the electronic display;
(b) applying a voltage differential across a cholesteric liquid crystal (CLC) layer that is disposed on the cathode; and
(c) adjusting a viewing angle of the electronic display during (b).

7. The method of claim 6, comprising:
(d) increasing a reflectivity of the CLC layer during (b); and
(e) decreasing a viewing angle of the electronic display during (d).

8. The method of claim 7, comprising:
(f) decreasing a reflectivity of the CLC layer during (b); and
(g) increasing a viewing angle of the electronic display during (f).

9. The method of claim 8, wherein (d) comprises applying a first voltage differential between the cathode and an electrode disposed on the CLC layer;
wherein (f) comprises applying a second voltage differential between the cathode and the electrode; and wherein the first voltage differential is greater than the second voltage differential.

10. The method of claim 6, wherein (c) comprises adjusting a viewing angle of the display in a first plane and adjusting a viewing angle of the display in a second plane that is perpendicular to the first plane.

11. An electronic display, comprising:
an organic light emitting diode (OLED);
an anode on a first side of the OLED;
a cathode on a second side of the OLED; and
a privacy cell coupled to the cathode opposite the OLED, wherein the privacy cell comprises:
a cholesteric liquid crystal (CLC) layer on the cathode; and
an electrode on the CLC layer opposite the cathode; and
a controller coupled to the privacy cell, the cathode, and the anode, wherein the controller is to apply a voltage differential across the CLC layer to selectively reduce a viewing angle of the electronic display.

12. The electronic display of claim 11, wherein the controller is to apply the voltage differential across the CLC layer to selectively reduce a viewing angle of the electronic display in a first plane and a second plane that is perpendicular to the first plane.

13. The electronic display of claim 12, wherein the controller is to apply a first voltage differential between the cathode and the electrode to increase a reflectivity of the CLC layer and to reduce the viewing angle of the electronic display.

14. The electronic display of claim 13, wherein the controller is to apply a second voltage differential between the cathode and the electrode to decrease a reflectivity of the CLC layer and increase a viewing angle of the electronic display.

15. The electronic display of claim 14, wherein the controller is to increase from the second voltage differential to the first voltage differential to increase the viewing angle of the electronic display relative to the difference between the first voltage differential and the second voltage differential.
